(19) United States
(12) Patent Application Publication
(10) Pub. No.: US 2020/0233410 A1
(43) Pub. Date: Jul. 23, 2020

(54) ELECTRIC FREIGHT TRAILER, SYSTEM AND METHOD

(71) Applicant: PROENSIS LLC, El Cajon, CA (US)

(72) Inventors: James S. BURNS, El Cajon, CA (US); Thomas L. BARTLEY, San Diego, CA (US)

(21) Appl. No.: 16/749,988

(22) Filed: Jan. 22, 2020

Related U.S. Application Data
(60) Provisional application No. 62/795,032, filed on Jan. 22, 2019.

(51) Int. Cl. G05D 1/00; B62D 59/04; B60L 50/60; B60L 1/00; B60L 7/18; B62D 5/04; G05D 1/02

(52) U.S. Cl. CPC G05D 1/0016; B62D 59/04; B60L 50/66; G05D 1/0223; B60L 7/18; B62D 5/046; B60L 1/003

(57) ABSTRACT

Aspects of the present disclosure generally pertains to freight trailers having onboard power. Aspects of the present disclosure more specifically are directed toward an electric freight trailer that can recycle the trailer braking energy of the towing vehicle, and also provide additional thrust to propel the freight trailer. Aspects of the present disclosure are also directed toward an electric freight trailer that can propel itself independently of a tractor, including steering and braking. Aspects of the disclosure are also directed toward additional subsystems that can utilize the trailer energy source.

### CROSS-REFERENCE TO RELATED APPLICATIONS

This application claims priority to U.S. provisional application 62/795,032, filed Jan. 22, 2019 and entitled ELECTRIC FREIGHT TRAILER, the contents of which are incorporated herein by reference in its entirety.

### BACKGROUND OF THE INVENTION

### Technical Field

The present disclosure generally pertains to freight trailers, and is more particularly directed towards freight trailers having onboard power.

### Related Art

It is common to move goods or haul freight using a tractor trailer combination truck vehicle called a “semi”. These vehicles weight over 10,000 lb. GVWR and may be lighter, but are typically rated as Class 8 or Class 7 heavy duty trucks. The tractor or prime mover has a propulsion unit to accelerate and move the combination truck trailer where the trailer is towed behind the tractor. The tractor and trailer each have their own braking systems controlled by the tractor driver, by means of a shared air pressure line. Independent of the tractor propulsion and braking systems, the trailer braking system uses air actuated mechanical friction brakes to decelerate the weight of the trailer and the freight load. The trailer brakes reject the heat energy from deceleration friction into the surrounding air.

Aspects of the present disclosure generally relate to braking energy regeneration systems and methods that capture and recycle wasted energy. The gross weight limit in California of a semitrailer resting on two tandem axles is 68,000 pounds with 34,000 pounds on the rear tandem axles. For other trailers the California weight limit is 18,000 pounds per axle. It is estimated that a 68,000 pound semitrailer traveling at 55 mph dissipates about 2.6 kWh of kinetic energy as heat and brake wear every time the semitrailer is slowed to a stop. At 75 mph the kinetic energy of a 68,000 pound trailer is 4.8 kWh. Therefore, the 34,000 pounds on the rear axles alone is responsible for 1.3 kWh and 2.4 kWh at 55 mph and 75 mph, respectively.

Hybrid drive systems for trucks and tow tractors have been in development for a number of years. It is known in hybrid drive systems for trucks and tow tractors to recover usually discarded braking energy. In particular, there exist methods to sense the pull and braking of the tow tractor, capture the trailer deceleration energy, and recycle the energy to assist the tractor during the next acceleration of the trailer in such a way that the trailer and freight appear as a lighter load to the towing tractor, thereby reducing the amount of propulsion energy consumed by the tractor during travel.

U.S. Pat. App. Pub. No. 20080174174 of Burns, et al. published on Jul. 24, 2008, shows a passive truck trailer braking regeneration and propulsion system and method. A braking regeneration and propulsion system for a passive trailer including wheels with axles includes a gear box to be operatively coupled to the axle; a motor/generator operatively coupled to the gear box; an energy storage system for storing captured energy and supplying energy; and a control computer to assist deceleration of the passive trailer by causing the axle to drive the motor/generator via the gear box and supply energy to the energy storage system during deceleration, and, assist acceleration of the passive trailer by causing the motor/generator to draw energy from the energy storage system and drive the wheels via the gear box and axle during acceleration. The axle may include a differential gearbox to split the drive from the gearbox to the wheels on each side of the vehicle.

U.S. Pat. No. 9,802,508 to Healy on Oct. 31, 2017, shows a motor vehicle accessory to increase available power and reduce fuel requirements. A power control system may include at least one of batteries, a motor, and a data logic analyzer that can interpret certain variable conditions of a transport, such as a tractor trailer, moving along a road or highway. The data can be used to determine when to apply supplemental power to the wheels of a trailer to reduce fuel usage. One example device may include at least one of: a power creation module that generates electrical power, a battery which store the electrical power, a motor affixed to a trailer axle of a trailer which provides a turning force to the trailer axle when enabled to operate from the stored electrical power of the battery, and a motor controller configured to initiate the motor to operate according to a predefined sensor condition.

The present disclosure is directed toward overcoming known problems and problems discovered by the inventors.

### SUMMARY OF THE INVENTION

Aspects of the present disclosure generally pertains to freight trailers having onboard power. Aspects of the present disclosure more specifically are directed toward an electric freight trailer that can recycle the trailer braking energy of the towed vehicle, and also provide additional thrust to propel the freight trailer. Aspects of the present disclosure are also directed toward an electric freight trailer that can propel itself independently of a tractor, including steering and braking.

A system for a freight trailer is disclosed herein. The freight trailer has a chassis, at least one drive wheel, and an air-powered braking system. The system includes an onboard drive system affixable to the freight trailer, an onboard air system affixable to the freight trailer, a power distribution system, and a controller affixable to the freight trailer. The onboard drive system includes an energy storage and a motor/generator electrically coupled to the energy storage, the motor/generator is configured to apply torque to the at least one drive wheel, the energy storage is configured to power the motor/generator and be charged by the motor/generator. The onboard air system includes an air compressor, an air pressure tank, and a supply-air line, with the supply-air line pneumatically coupleable to the air-powered braking system of the freight trailer. The air compressor is configured to fill the air pressure tank, and the air pressure tank is pneumatically coupled to the supply-air line and configured to provide supply air to the air-powered braking system of the freight trailer. The power distribution system is electrically coupled to the energy storage of the onboard drive system, and is configured to electrically power the air compressor of the onboard air system. The controller is configured to operate the onboard drive system and the onboard air system in both propulsion and braking.

According to one embodiment an electrified trailer is also disclosed herein. The electrified trailer includes a freight trailer, an onboard drive system affixable to the freight trailer, an onboard air system affixable to the freight trailer, a power distribution system, and a controller affixable to the freight trailer. The freight trailer has a chassis, at least one drive wheel, and an air-powered braking system. The onboard drive system includes an energy storage and a motor/generator electrically coupled to the energy storage, the motor/generator is configured to apply torque to the at least one drive wheel, the energy storage is configured to power the motor/generator and be charged by the motor/generator. The onboard air system includes an air compressor, an air pressure tank, and a supply-air line, with the supply-air line pneumatically coupleable to the air-powered braking system of the freight trailer. The air compressor is configured to fill the air pressure tank, and the air pressure tank is pneumatically coupled to the supply-air line and configured to provide supply air to the air-powered braking system of the freight trailer. The power distribution system is electrically coupled to the energy storage of the onboard drive system, and is configured to electrically power the air compressor of the onboard air system. The controller is configured to operate the onboard drive system and the onboard air system in both propulsion and braking.

A method for moving a freight trailer is also disclosed herein. The method includes providing an electrified trailer, where the electrified trailer includes the freight trailer, the onboard drive system, the onboard air system, and the controller as described above, as well as a means for steering the electric freight trailer and a power distribution system electrically coupled to the energy storage of the onboard drive system. The power distribution system is configured to electrically power the air compressor of the onboard air system and to electrically power the means for steering the electric freight trailer. The method further includes propelling the electrified trailer via the onboard drive system, braking the electrified trailer via the onboard air system, and steering the electrified trailer via the means for steering the electric freight trailer.

### BRIEF DESCRIPTION OF THE DRAWINGS

FIG. 1 is a schematic diagram of an electric freight trailer in an “in use” condition, according to one embodiment of the disclosure.

FIG. 2 is a schematic diagram of an electric freight trailer according to one embodiment of the disclosure.

FIG. 3 schematically illustrates a propulsion and braking system and subsystems of an electric freight trailer, according to one embodiment of the disclosure.

FIG. 4 schematically illustrates a drive system and subsystems of an electric freight trailer, according to one embodiment of the disclosure.

FIG. 5 schematically illustrates an air system including a braking system and subsystems of an electric freight trailer, according to one embodiment of the disclosure.

FIG. 6 schematically illustrates a control architecture of various systems and subsystems of an electric freight trailer, according to one embodiment of the disclosure.

FIG. 7 schematically illustrates an autonomous dolly for an electric freight trailer, according to one embodiment of the disclosure.

FIG. 8 schematically illustrates a freight trailer retrofitted as an electric freight trailer, according to another embodiment of the disclosure.

FIG. 9 schematically illustrates a conventional braking system of a freight trailer.

FIG. 10 schematically illustrates another conventional braking system of a freight trailer.

### DETAILED DESCRIPTION

Aspects of the present disclosure relate to freight trailers having onboard power. Aspects of the present disclosure generally pertain to freight trailers having onboard power. Aspects of the present disclosure more specifically are directed toward an electric freight trailer that can recycle the trailer braking energy of the towed vehicle, and also provide additional thrust to propel the freight trailer. Aspects of the present disclosure are also directed toward an electric freight trailer that can propel itself independently of a tractor, including steering and braking.

Briefly described and generally, the disclosure relates to advanced motor/generator controls for supplying torque to the trailer active axle and charging the battery from the generator. Other features include adding a house battery and electric system to the trailer; adding an inverter, a brake relay controller, and an air compressor to the trailer, eliminating the need for the “Glad Hands” (i.e., coupling devices used to connect the service and emergency air lines from the truck or tractor to the trailer); adding wireless control communication between the tractor and the trailer; adding inverters and DC to DC converters to provide power to lighting systems, refrigeration and HVAC systems, household appliances, freight positioning systems, dynamically controlled air drag reduction systems, battery management techniques, alternative battery charging ports such as from the grid or inductive charging loops, and other auxiliary and charging and power generation systems.

Various aspects of the novel systems, devices, and methods are described more fully hereinafter with reference to the accompanying drawings. The detailed description set forth herein, in connection with the appended drawings, is intended as a description of various configurations and embodiments, and is not intended to represent the only configurations in which the concepts described herein may be practiced. The detailed description includes specific details for the purpose of providing a thorough understanding of various concepts. In particular, it will be apparent to those skilled in the art that these concepts may be practiced without these specific details. In some instances, well known structures and components are shown in block diagram form to avoid obscuring such concepts.

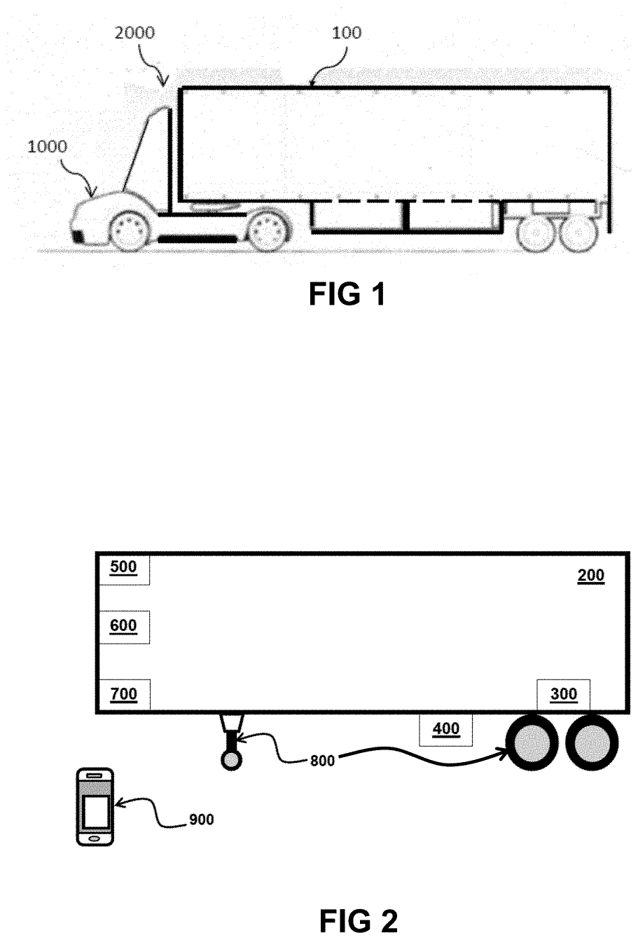

FIG. 1 is a schematic diagram of an electric freight trailer in an “in use” condition, according to one embodiment of the disclosure. Here, an electric freight trailer 100 is shown according to one exemplary embodiment. In particular, the electric freight trailer 100 is shown embodied as an electric semi-trailer. In other embodiments, the electric freight trailer 100 may be arranged an electric (full) trailer.

As shown, the electric freight trailer 100 may be configured to couple with an autonomous tow vehicle 1000. Here, the autonomous tow vehicle 1000 is shown with its faring deployed. Together the electric freight trailer 100 and the autonomous tow vehicle 1000 may combine as an autonomous electric semi-trailer truck 2000. Alternately, the electric freight trailer 100 may be configured to couple with a tractor unit 10 (FIG. 8). Together the electric freight trailer 100 and the tractor unit 10 may combine similar to a conventional semi-trailer truck including a tractor and one or more semi-trailers.

With regard to the basic mode of operation, the electric freight trailer 100 recycles the trailer braking energy, independent of the towing vehicle (e.g., autonomous tow vehicle 1000). Further, the electric freight trailer 100 may provide additional thrust to propel the electric freight trailer 100 and to assist, but not push, the towing vehicle during acceleration, and may provide additional drag to slow the trailer and to assist the towing vehicle's deceleration braking. For example, the electric freight trailer 100 may provide a partial assist to the towing vehicle up to a threshold. The result is that the towing vehicle “senses” or “experiences” a lighter tow load, while the electric freight trailer 100 applies the drag to drive the generator, and then to store generated braking energy in an onboard energy storage during deceleration. The stored energy is then recycled from the energy storage into a drive motor to provide thrust during acceleration. The drive motor and generator may be embodied as a single unit electromechanical machine that can be used as either a motor or a generator.

As discussed further below, additional accessories and auxiliaries may be added to the electric freight trailer 100. Further, a trailer master control computer can control and monitor the accessories, auxiliaries, and provide a wireless link for remote operation and control of the trailer refrigeration unit, accessories and subsystems, and steering, braking, and propulsion.

FIG. 2 is a schematic diagram of an electric freight trailer according to one embodiment of the disclosure. In particular, the electric freight trailer 100 is arranged here as a semi-trailer. As shown, the electric freight trailer 100 may include a chassis 200, an onboard drive system 300, an onboard air system 400, and a controller 500. In addition, the electric freight trailer 100 may include a household power system 600, and/or one or more auxiliary systems 700. Further, the electric freight trailer 100 may include a trailer steering system 800. In addition, the electric freight trailer 100 may include or otherwise be operable with a remote user interface 900. The remote user interface 900 may come in many forms and is broadly defined as a user interface separate and distinct form the operational controls of the tractor. In particular, remote user interface 900 controls the electric freight trailer 100 but not the tractor. However, the remote user interface 900 may be affixed to the tractor, to the trailer, and/or may be portable/mobile. Further the remote user interface 900 may provide for bidirectional communication providing for commands and feedback. For example, the remote user interface 900 may provide the operator and/or the tractor (and/or the controller 500) with operational, performance, and/or emergency information (e.g., break away trailer, insufficient traction/braking on the trailer-side, etc.). The remote user interface 900 may have a HUD or status reporting display and/or audio in the tractor. The remote user interface 900 may also have status lights on the trailer viewable from the tractor rear view mirror. Further, the controller 500 may interpret these communications for independent action/response. For example, the controller 500 may implement a “breakaway protocol” such as: If the trailer is moving and there is no force vector on the kingpin for a length of time, then the trailer is on its own and should start a “slowdown and stop protocol”. Also for example, if there is a tractor-side air failure or if the tractor loses air pressure to the trailer, the tractor brakes may still signal application without coming on, however the trailer will follow suit to decelerate. Likewise, if the tractor is a runaway, the trailer could apply brakes and regen to decelerate both if the controller 500 got a signal from the tractor/driver via the remote user interface 900 or otherwise.

The chassis 200 may include a trailer configured as a towed vehicle with a front mounted structural tow point such as a fifth-wheel coupling including a kingpin. The trailer has a load support structure extending rearward from the tow point to one or more rear axles. The load support structure may be arranged as a flat bed, tank, refrigeration box (reefer), dry goods box, multimodal removable container, or any other custom trailer intended to be towed behind a tractor with a fifth wheel tow coupling/kingpin and air brakes.

Preferably, the chassis 200 is arranged as heavy-duty semi-trailer. In particular, the chassis 200 may be configured to support a minimum weight limit (e.g., for a heavy-duty trailer between 4,000 and 9,000 pounds). The semi-trailer (chassis 200) includes but is not limited to: refrigeration (reefer), dry goods, flat bed, container multimodal, tank, or specialty custom trailer intended to be towed behind a tractor with a fifth wheel tow coupling and air brakes.

The onboard drive system 300 may generally be configured as an electric vehicle drive system for a heavy duty vehicle, and include a motor/generator, gearing, an energy storage, and a power distribution system. The onboard air system 400 may generally be configured similar to a conventional air system for a tractor unit 10 of a conventional semi-trailer truck, and include an air compressor, an air pressure tank, and appropriate plumbing and control to operate air brakes of the electric freight trailer 100. Together, aspects of the onboard drive system 300 and the onboard air system 400 provide for propulsion (including propulsion assist) and braking (including braking assist) of the electric freight trailer 100, and may further provide propulsion and braking towards the towing vehicle.

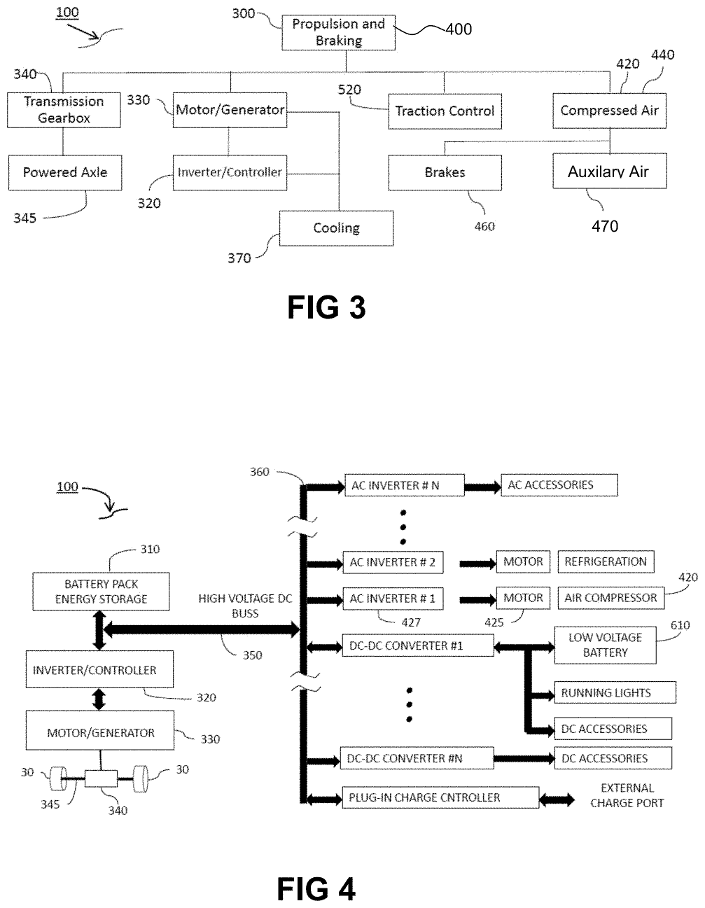

FIG. 3 schematically illustrates a propulsion and braking system and subsystems of an electric freight trailer, according to one embodiment of the disclosure. It should be noted, the onboard drive system 300 and the onboard air system 400 are illustrated above as separate modules for convenience and clarity. Notwithstanding, components and functionality of each may be combined or otherwise shared (as shown here), which may include shared/combined operational structures and components (as well as control architecture).

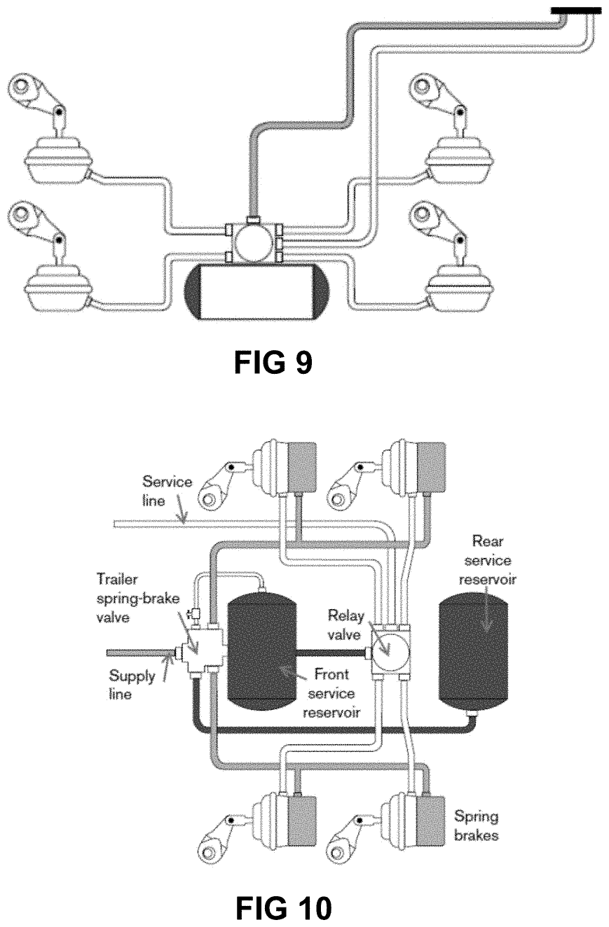

Propulsion and braking may be provided by components and functionality of the onboard drive system 300 and the onboard air system 400 together. Generally, at least one of the axles is actively connected to the shaft or output of at least one motor/generator unit connected to at least one of the wheels of the electric freight trailer 100 directly, or through a torque shaft to a differential gearbox. Similarly, the onboard air system 400 is operationally coupled to the compressed air brakes 462 of the electric freight trailer 100 (e.g., pneumatically coupled via a glad hand coupling or the like). It is understood that the compressed air brakes 462 may vary from trailer to trailer, but generally include foundation or spring brakes and other conventional equipment as exemplarily shown in FIGS. 9-10, and are typically operable via supply air and service air.

As shown, the onboard drive system 300 of the electric freight trailer 100 may include a transmission gearbox 340 coupled to a powered axle 345. The powered axle 345 is driven and braked by a reversible motor/generator 330. According to one embodiment, the onboard drive system 300 may include multiple axles and/or wheel motors/generators.

According to one embodiment, the motor/generator 330 may be operatively coupled to a multi-speed transmission gearbox operatively coupled to the powered axle 345. Further, the motor/generator 330, the transmission gearbox 340, and/or the powered axle 345 may be incorporated into one unit, similar to an E-axle. As above, according to one embodiment, the transmission gearbox 340 may include a multi-speed transmission gearbox operatively coupled to a differential gearbox. Alternately, the powered axle 345 may include the differential gearbox, which operatively couples the multi-speed gearbox 340 to the axle shafts of the wheels 30 on each side of the electric freight trailer 100. Beneficially, in these various embodiments, the multi-speed transmission gearbox may be controlled so as to optimally match the torque of the powered axle to the efficient RPM of the motor/generator, providing for efficient operation.

As above, the motor/generator unit 330 may be connected directly or through a multispeed or gear reduction transmission gearbox 340. The motor/generator unit 330 may also be thermally coupled to or otherwise incorporate a cooling module 370, particularly for excess heat generated during regenerative braking. It should be understood that there may be significant differences in layout of these various modules, for example based on desired performance, convention, and trailer application, to name a few.

The motor/generator 330 may be electrically connected to an inverter/controller of its power electronics 320 for mode control, and for conduction of electrical energy to and from an energy storage 310 (FIG. 4). The motor/generator 330 may also be electrically connected to a traction controller 520. The energy storage 310 may be embodied as a battery pack that includes a battery management system (BMS) for control of the balancing and equalization of individual battery cells, especially during charge and discharge operation.

The energy storage 310 of the electric freight trailer 100 may include, but is not limited to, batteries, flywheels, fuel cells, solar cells, and APUs (Auxiliary Power Units) fueled by hydrogen, natural gas, propane, diesel and gasoline. Further, the energy storage 310 of the electric freight trailer 100 may be configured for other optional capabilities, for example, to accept and supply power for V2X applications. For example, the V2X applications may include, but are not limited to: vehicle-to-grid, V-to-other vehicles, V-to-buildings, V-to-remote, and V-to-temporary facilities.

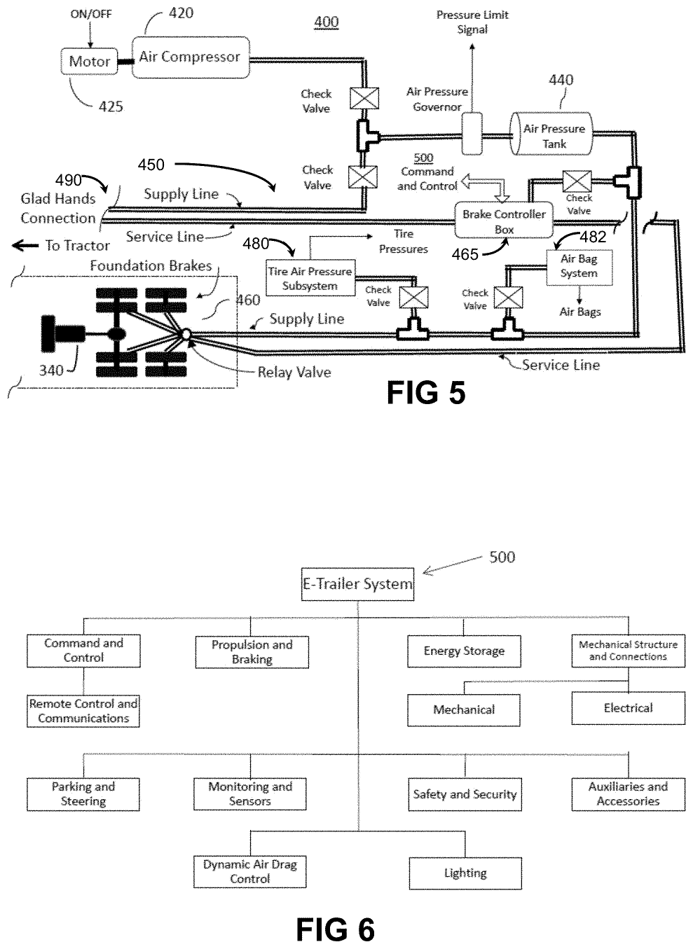

Generally, the onboard air system 400 of the electric freight trailer 100 may include a compressed air system (e.g., including an air compressor 420 and at least one reservoir such as compressed air tank 440) configured to provide trailer friction braking via an air brake system 460, as well as to provide auxiliary pneumatic services via an auxiliary pneumatic system 470. Examples of the auxiliary pneumatic services may include maintaining tire pressure via a tire pressure system 480 and/or maintaining air bag pressure via an air bag suspension system 482 (FIG. 5). In particular, the air compressor 420 output has air lines connected to the trailer compressed air tanks 440 and air brake system 460. The air lines may be configured for both supply and control. The air compressor 420 may have a mechanical input shaft that is mechanically connected to an electric motor shaft of a compressor driver. Accordingly, the wheels are driven by the powered axle 345 and braked by one or both of the powered axle 345 and the compressed air brakes 462.

FIG. 4 schematically illustrates an onboard drive system and various subsystems of the electric freight trailer, according to one embodiment of the disclosure. Here, the onboard drive system 300 generally includes an energy storage 310, power electronics 320, a motor/generator 330, and a transmission 340. The energy storage 310 is electrically coupled to the motor/generator 330 via the power electronics 320. The motor/generator 330 is coupled to one or more wheels 30 of the electric freight trailer 100 via the transmission 340.

According to one embodiment, the motor/generator 330 that is coupled to the one or more wheels 30 via a transmission gear box 340 may be contained in a single unit, such as an E-axle. Together the onboard drive system 300 is configured to propel or assist propel the electric freight trailer 100, and also to regeneratively brake or assist braking the electric freight trailer 100. Preferably, and as above, the transmission gear box 340 may be configured as multi-speed transmission having gear ratios configured to optimally match the powered axle torque to the efficient RPM of the motor/generator 330.

According to one embodiment, the drive system may include a high voltage bus 350 and auxiliary power electronics 360. The high voltage bus 350 may be electrically coupled between the energy storage 310 and/or the power electronics 320, and to the auxiliary power electronics 360. The high voltage bus 350 may be configured to provide power to the auxiliary power electronics 360. The auxiliary power electronics 360 may include one or more AC inverters, DC-DC converters, and plug-in chargers. The auxiliary power electronics 360 may be configured to power one or more auxiliary loads, such as AC accessories, a refrigeration motor, the air compressor 420, a low voltage battery (e.g., 6 VDC, 12 VDC, 24 VDC, 48 VDC), DC accessories (e.g., running lights), and an external charge port.

FIG. 5 schematically illustrates an air system including a braking system and auxiliary pneumatic systems of an electric freight trailer, according to one embodiment of the disclosure. In general, the onboard air system 400 may be configured for both pneumatic supply and control onboard the electric freight trailer 100. As shown, the onboard air system 400 may include one or more air compressors 420, one or more reservoirs or air pressure tanks 440, and appropriate plumbing and control 450 to operate the compressed air brakes 462 and the auxiliary pneumatic system(s) 470 of the electric freight trailer 100. Here, a tire pressure system 480 and an air bag suspension system 482 are illustrated as merely exemplary auxiliary pneumatic systems, however, it should be understood that numerous other auxiliary pneumatic systems are contemplated. In should be further understood that the onboard air system 400 may be operational with and without a pneumatic connection to the tractor, as discussed below.

Generally, the onboard air system 400 may be configured for both pneumatic supply and control. In particular, the onboard air system 400 may operate as if the electric freight trailer 100 were coupled to the tractor, independently of an actual pneumatic coupling (e.g., via glad hands), supplying both operational air (supply-air and/or service-air) and signaling (service-air and/or operator pedal-input) for operation.

According to one embodiment, the onboard air system 400 may include both a supply-air circuit and a service-air circuit. According to another embodiment, the onboard air system 400 may still include the supply-air circuit but instead incorporate electronic actuation of at least one of the compressed air brakes 462 and the auxiliary pneumatic system(s) 470.

Regarding supply-air, according to one embodiment, the air compressor 420 output may be pneumatically coupled to, and configured to supply, the one or more air pressure tanks 440. The one or more air pressure tanks 440 may then be pneumatically coupled to, and configured to supply, the air brake system 460 and/or the auxiliary pneumatic system(s) (e.g., the tire pressure system 480 and the air bag suspension system 482). According to one embodiment, air compressor 420 output may be pneumatically coupled to, and configured to supply, the air brake system 460 and/or the auxiliary pneumatic system(s) directly.

Regarding service-air, according to one embodiment, the onboard air system 400 may be further configured to provide for control during braking application and other brake operation (e.g., parking, breakaway, etc.). In particular, the plumbing and control 450 of the onboard air system 400 the onboard air system 400 may include a brake controller 465 (e.g., a brake control box and/or brake relay module).

Without the glad hands of the tractor being pneumatically coupled to the electric freight trailer 100, the brake controller 465 sends the correct braking air pressure to the trailer relay valve. Further, the brake controller 465 would have input from a tractor mounted glad hands sensing box that wirelessly sends that data to the trailer control box. That box also has to handle emergency air loss events. According to one embodiment, the brake controller 465 may be communicably coupled with the sensing box for closed communications back to the tractor driver reporting the status of the trailer brakes. In addition, or alternatively, the trailer control box (brake controller 465) may have sensor inputs from the trailer king pin as to the amount and direction of force applied to the king pin that will result in trailer movement. For example, a solenoid servo shaft may be employed to match the driver's brake foot pedal. Preferably, with sensors for the trailer weight, speed, slope, and king pin force vector, the control box wouldn't need any information from the tractor glad hands to manage the trailer air braking and blending with the regeneration electric braking.

The brake controller 465 may be generally configured to operate the compressed air brakes 462, particularly when the electric freight trailer 100 is pneumatically decoupled from the tractor vehicle. In particular, the brake controller 465 may be configured to communicate brake commands from a trailer operator to the onboard air system. The signaling may be communicated to the electric freight trailer 100 via a physical communication link and/or via a wireless communication link.

To illustrate, where service air (and supply air) is physically provided from the tractor (e.g., the autonomous tow vehicle 1000, the tractor unit 10, etc.), the plumbing and control 450 of the onboard air system 400 may include a glad hands trailer coupling (similar to conventional air operations). Accordingly, the onboard air system 400 may operate as a conventional freight trailer (in this regard) when the glad hands are coupled.

Also to illustrate, where service air (and supply air) is not physically provided from the tractor, service air may be provided to the compressed air brakes 462 of the electric freight trailer 100 by the one or more air pressure tanks 440, via the plumbing and control 450 of the onboard air system 400, and in response to signaling from the tractor. In particular, the brake controller 465 may be configured to interpret the signaling from the tractor, and to operate the compressed air brakes 462 accordingly. For example, in response to signaling that the air brakes have been applied by an operator, the compressed air brakes 462 may be actuated via application of local/onboard service-air of the electric freight trailer 100. Alternately, in response to signaling that the air brakes have been applied by an operator, the compressed air brakes 462 may be actuated via direct energizing methods (e.g., electrically actuated brakes).

The brake controller 465 may be actuated or otherwise operated/commanded by actual tractor service air on the tractor-side (e.g., transducers coupled to the glad hands) and/or from signaling from a tractor braking control interface (e.g., pedal sensors). For example, the brake controller 465 may include a tractor braking control interface affixable to the tractor, where the tractor braking control interface is configured to signal an application of a tractor air-powered braking system by the trailer operator. This may be in any convenient form, but preferably with utilize preexisting operator controls (e.g., brake pedal, emergency brake, etc.) and communicate their application by the operator to the onboard air system 400.

Further, the brake controller 465 may be actuated or otherwise operated/commanded by other tractor-side sensors and sensor modules (“sensing box”) communicably coupled with the brake controller 465 and/or trailer-side sensors and sensor modules (“trailer control box”). For example, the sensors and sensor modules may establish a force vector on the kingpin (e.g., using strain gages). Other sensor (transducer) needs are the trailer weight on the axles, moisture and rain, snow, ice/road surface sensing for traction control, slope for gravity vector (may be able to get it from the kingpin force vector), light level for running lights, speed and direction, apparent wind speed, wheel/tire rpm, trailer elevation (pitch), yaw, and roll, doors open/closed, and any load status. Shock sensors may also be employed.

Accordingly, the onboard air system 400 may be further configured to provide supply air and/or service air to the air-powered braking system 460 of the freight trailer responsive to brake commands of the trailer operator communicated to the onboard air system 400 via the tractor braking control interface of brake controller 465.

According to one embodiment, the tractor braking control interface of the brake controller 465 may include a pressure transducer pneumatically coupled to a tractor service-air line. The pressure transducer may be configured to signal the application of the tractor air-powered braking system by the trailer operator in response to sensed pressured in the tractor service-air line. The tractor braking control interface may be further configured to signal the application of the tractor air-powered braking system by the trailer operator via a wireless communication link. For example, the pressure transducer may be integrated into a glad hands interface that couples to the tractor-side glad hands coupling, and communicates brake application to the brake controller 465 via sense service air pressure. As above, this signaling may be communicated by wired or wireless link.

The onboard air system 400 may further include a tire pressure system 480, which is generally configured to maintain tire pressure of the wheels 30 of the electric freight trailer 100. Aspects of the onboard air system 400 may be configured similar to the braking system and subsystems of the tractor unit of a conventional semi-trailer truck.

The onboard air system 400 may further include an air bag suspension system 482, which is generally configured to inflate trailer suspension air bags of the electric freight trailer 100. Aspects of the onboard air system 400 may be configured similar to the air bag suspension system and subsystems of the tractor unit of a conventional semi-trailer truck.

The onboard air system 400 may further include one or more auxiliary air systems, which are generally configured to supply local/onboard air for actuation or as a power source. The auxiliary air systems may be plumbed within or otherwise integrated with the electric freight trailer 100. Likewise, the auxiliary air systems may include an external air pressure connection such as a “glad hands coupling” 490, which can be used to power auxiliary air-powered tools, for example.

The onboard air system 400 may further include an external air tank air pressure connection that can be used to power auxiliary air-powered tools, for example. This may be embodied as the glad hands coupling” 490, and/or may be embodied as a dedicated fill port configured to pressurize air pressure tank 440. Beneficially, the onboard air system 400 may be able to be charged and at least partially operational in the event the electric freight trailer 100 needs to be moved, the safety air brakes are locked, and there is no air pressure source available through the “glad hands” 490.

According to one embodiment, the onboard air system 400 may be mounted or otherwise added to the electric freight trailer 100 by mechanically mounting the air compressor 420, an air compressor electric motor 425, and an inverter drive unit 427 (FIG. 4) on the electric freight trailer 100. The air compressor 420 may be integrated with or otherwise mechanically connected to the air compressor electric motor 425. The electric motor 425 can accept electric input power through an electric connection to one of an AC inverter 427, a DC to DC converter, or direct connection to a battery.

The input electric power connection may be connected to a solid state switch or a mechanical switch such as a contactor to switch the air compressor ON/OFF, for example, either by an air pressure governor sensor/switch or from the master control computer. According to one embodiment, the on/off control of the air compressor may be through an air pressure governor that actuates electrical contacts to turn on the air compressor when the air tank pressure drops below a minimum pressure setting.

According to one embodiment, the onboard air system 400 may be powered through an electrical connection (e.g., high voltage bus 350) to the AC inverter driver 427, which is electrically connected to and receives power from the trailer propulsion battery (energy storage 310). Alternatively, the air compressor electric motor 425 could be a DC motor and receive power directly from the trailer house battery 610 (FIG. 4).

According to one embodiment, the onboard air system 400 of the electric freight trailer 100 may include the air brake system 460. The air brake system 460 may then include the compressed air brakes 462 (e.g., foundation or spring brakes and other conventional equipment as shown in FIGS. 9-10). For example, the onboard air system 400 may be part of or otherwise incorporate an air system that is already part of a conventional trailer air brake system, and which is mounted as standard equipment on the heavy-duty trailer. For example, the air pressure tank 440 may be embodied as an existing air tank pressure reservoir. Also, the compressed air brakes 462 and associated plumbing and control 450 may be at least partially embodied as preexisting standard equipment.

Beneficially, with the electric freight trailer 100 having its own air compressor 420, this external air pressure connection can be used to inflate trailer suspension air bags and power auxiliary air-powered tools. In particular, while the primary purpose of the air system is for the trailer air brakes, a plurality of air systems could be added to the trailer for purpose including but not limited to: moving cargo or positioning aerodynamic surfaces to minimize air drag. According to one embodiment, the braking system of the electric freight trailer 100 may be configured as an advanced electrically actuated electric brake, or include an advanced electrically actuated electric and air brakes in a brakes control box which supplies control air pressure (e.g., service air) to the air brakes relay valve.

FIG. 6 schematically illustrates a control architecture of various systems and subsystems of an electric freight trailer, according to one embodiment of the disclosure. Here, the controller 500 is described generally, but may include one or more modules configured to operate the various systems and subsystems of the electric freight trailer 100.

Further, the one or more modules may be dedicated to a particular functionality, generally to the entire electric freight trailer 100, or any combination thereof. For example, the controller 500 may be embodied as a master computer control unit that is electrically connected to an inverter controller, a battery management system (BMS), a suite of sensors, and an onboard wireless communication system. The various sensors may include sensors configured for measurement of location, acceleration, speed, weight, temperature, humidity, elevation, tire air pressure, kingpin force vector, and/or any other environment or equipment conditions useful to the master computer control logic. The sensor inputs to the computer can be analog, digital, direct wired or wireless radio. One embodiment of a wireless communication system is plugging a Bluetooth communication unit into the socket for the tractor onboard data and diagnostic CAN buss and broadcasting that information to a Bluetooth receiver unit connected to the trailer master control computer.

As shown, the electric freight trailer 100 may include systems that provide for command and control (including remote control and communications), braking and propulsion, and energy storage, as well as appropriate mechanical structure and connections for any mechanical or electrical requirements of the electric freight trailer 100. In addition, the electric freight trailer 100 may include systems directed toward parking and steering, monitoring and sensing, safety and security, dynamic air drag control, and lighting. Further, the electric freight trailer 100 may include systems directed toward auxiliary systems and accessories.

The controller 500 may include one more modules configured to operate the onboard drive system 300 and the onboard air system 400 for both propulsion and braking (including assist). For example, aspects of the controller 500 may include any combination of sensors, programmed control logic, and the like that is configured to sense the +/− inertial and +/− gravity forces to provide an estimate for inputs to the control logic which then determines the desired counter thrust, i.e., motor for acceleration or generator for braking. In particular, the controller 500 may combine sensor information of +/− inertial, +/− gravity, and location inputs to estimate and predict the desired counter thrust for the motor for acceleration and generator for braking.

The electric freight trailer's control logic may command a torque value in response to comparing the desired speed with the actual calibrated measured (sensed) speed and acceleration. In particular, the controller 500 may determine and issue a torque command value resulting from a comparison of desired and actual speed. Further, the transmission 340 (e.g., a multispeed gearbox) may use a dynamic compliance matching as embodied in the control logic of the controller 500 to determine transmission shift points for the maximum motor/generator efficiency.

According to one embodiment, the controller 500 may transfer energy from the prime mover to the energy storage 310 via the wheels 30 and the road. In particular, the control logic of the controller 500 may also turn on or otherwise control a generator mode of the motor/generator 330 to charge the trailer batteries (energy storage 310) to a desired level from the pulling tractor as a type of ground coupled hybrid drive. For example, upon determining a desire to charge the energy storage 310, the controller 500 may provide for “ground coupled tractor charging” of the trailer batteries (energy storage 310) by engaging or otherwise operating the motor/generator 330 as a brake or generator (potentially requiring additional output from the prime mover) and thus charge the energy storage 310. In this way the prime mover could charge the energy storage in anticipation of operating the refrigeration unit and/or driver HVAC and household loads when parked.

According to one embodiment, the controller 500 may be configured to operate or otherwise control one or more onboard power or communication operations of the electric freight trailer 100. For example, the controller 500 may manage external ports for charging and discharging of the trailer main batteries (energy storage 310). Also, for example, the controller 500 may manage the energy transfer between the house batteries and the trailer main batteries. Also, for example, the controller 500 may provide for and manage the wireless communication with the tractor control and the trailer control when the glad hands 490 are removed, particularly where the glad hands 490 provide a wired signaling or communications link.

According to one embodiment, the controller 500 may be configured to operate or otherwise enhance the performance of the electric freight trailer 100. To illustrate, the controller 500 may include a trailer traction control module 520 dedicated for trailer side propulsion and regenerative braking. Generally, the trailer computer control module may include software logic that controls the two-way power and energy flow between the propulsion battery and the motor/generator unit to assist the towing tractor. For example, during the generator operating mode, the trailer computer control module may provide braking to the trailer. In particular, the control system may blend normal service brakes (friction brakes) with the drag created by the generator to provide a seamless integrated deceleration compatible with the standard wheel slip control ABS (Anti-Skid Braking) operation.

According to one embodiment, the controller 500 may incorporate and use of weight sensor inputs to limit motor/generator torque to prevent wheel locking and slipping. In particular, the controller 500 may include a weight sensor on the trailer suspension, which is configured to send sensed information to the traction control computer for the control logic to set motor/generator torque limits to prevent wheel locking and slipping (e.g., anti-slip or ABS).

Further, the controller 500 may incorporate and use angle position sensors for each of the tractor and trailer to increase generator drag to keep the tractor trailer combination in a straight line for stability control and jackknife prevention. In particular, the controller 500 may include angle position sensors, which are configured to send tractor position angles and the trailer position angles to be compared by controller 500, and when out of limit the controller 500 can increase the trailer generator drag to move the trailer inline behind the tractor for additional stability control, and thus trailer jack knife prevention. According to another embodiment, the controller 500 can send brake control commands to the brake control box and air relay valves to each wheel to adjust the amount of friction drag at each wheel to maintain a stable position angle torque for the trailer-tractor straight line orientation.

According to one embodiment, the controller 500 may provide for trailer steering. In particular, the controller 500 may incorporate and use differential torques on rear wheel motors and or brakes for rear wheel steering (e.g. for enhanced turning or as the trailer steering system 800). For example, traction control on the trailer's “active” or powered axle, may add or otherwise provide for rear wheel steering and/or front wheel steering. This may be beneficial to propel and position the trailer without the tow tractor. For example, once the electric freight trailer 100 has a propulsion motor, steering, a master control unit and wireless communication, it can be operated remotely or autonomously for operations such as self-parking.

Returning to FIG. 2, the household power system 600 may include a house battery and electric system added to and configured to provide low voltage power to the electric freight trailer 100. In particular, the household power system 600 may include a DC-DC converter and/or a trailer “house load” battery (12 VDC to 48 VDC), and an inverter for AC power to provide non-propulsion DC and AC power to the trailer. For example, the household power system 600 may incorporate an optional power distribution system to the trailer for household loads by adding or otherwise including a 110-120 VAC power distribution panel box to receive one, or two phase 220/120 VAC standard recreational vehicle (RV) power and distribute 110/220 VAC power through safety circuit breakers to lighting, electronics, appliances and power plug-in outlets as needed throughout the trailer. Further, the source of the AC power may be one or more of an inverter electrically coupled to the high voltage DC bus, the low voltage DC bus, or an external connector configured to receive external grid or generator power. Also for example, the household power system 600 may incorporate a power distribution system to the trailer for household loads by adding or otherwise including a low voltage power distribution system configured to receive power from the low voltage DC bus and distribute low voltage DC power through safety circuit breakers to lighting, electronics, appliances and power plug-in outlets as needed throughout the trailer.

The household power system 600 may be configured to provide household power for one or more of the following purposes, including, but not limited to: running, brake, and auxiliary lighting, refrigeration power for “reefers”, control of dynamic air stream actuators for air drag management, power for electronic controls and communications, household appliances and electrically powered tools power, control and operation of solar energy panels for charging the batteries, and control and operation of hydraulic pumps such as a lift gate for the purpose of moving and lifting goods. The DC to DC converter is a bidirectional converter to exchange energy between the house battery and the main propulsion battery for the purposes of, including but not limited to: balancing cells in the battery packs, extending the use of the house battery, and providing energy to the propulsion battery pack to extend the trailer electric propulsion range.

According to one embodiment, the household power system 600 and/or specifically the plug in charge controller of FIG. 4 may include one or more external power physical connectors and/or inductive ports. In particular, the external power physical connectors and/or inductive ports may be configured for the transfer of energy to and/or from the trailer main propulsion batteries. For example, the physical connectors require metal to metal contact for electric current conduction, whereas the connectors are held together by friction, clamps, or magnetic attraction. Also for example, the inductive charging port may be of the wireless design where energy transfers by means of a magnetic field between two inductive coils located in proximity to each other, typically, one on the underside of the vehicle and one on or embedded into the surface below the vehicle. Preferably, the connectors and ports will conform to industry standards for the respective type of power supply. According to one embodiment, one or more of the external connections or ports may include a communications link configured to transfer control logic or other information.

According to one embodiment, at least one external power connection or port may electrically connect to a battery charger. In particular, this connection may include power electronics and circuitry appropriate for the purpose of charging the propulsion battery. Alternately, the charger can be part of the inverter control unit of the motor/generator. According to one embodiment, the external power link and charger can accept at least one of AC or DC power.

According to another embodiment, the household power system 600 and/or specifically the plug in charge controller of FIG. 4 may include a bidirectional external power connection or port and a battery charger, where the charger is configured to provide a Vehicle to Grid (V2G) connection. The charger may be further configured to provide power management services. To illustrate, the power management services may include an aggregation of multiple vehicles to provide services such as voltage and frequency control to the utility power grid. This may be beneficial as an interface to utilities having limited capacity to receive externally generated power. According to another embodiment, the bidirectional external power connection or port, the battery charger, and the charger can be configured to provide AC and/or DC power to an external load including but not limited to: a building, another vehicle, a shelter, a tent, emergency services, or other remote operations.

The auxiliary systems 700 may include any number of additional system that may be beneficial to the operation of the electric freight trailer 100, including drive/braking and specific functionality. For example and in addition to other auxiliary systems discussed throughout the present disclosure, the auxiliary systems 700 may include at least one of a hydraulic system and various operational electric motors.

According to one embodiment, the auxiliary system 700 may include one or more electrically powered hydraulic systems. In particular, the auxiliary system 700 may incorporate one or more hydraulic systems configured for purposes to include, but not limited to: moving cargo goods horizontally along the length and width of the trailer or vertically from the ground to any place on or above the trailer bed, e.g., a lift gate; operating actuators to position aerodynamic surfaces dynamically to optimize aerodynamic trailer drag for any specific speed or wind condition. In each case, the hydraulic system may include a hydraulic fluid reservoir, or shared reservoir; a hydraulic fluid filter; a hydraulic pump to pressurize the hydraulic fluid, a load that uses the pressurized fluid through an expanding volume, e.g., a piston inside of a cylinder, to mechanically move an actuator rod that may be mechanically linked to a structure designed to push, pull, rotate, lift, or drop objects of some weight; high pressure hoses to transport the high pressure fluid from the hydraulic pump to the load; and low pressure hoses to transport the hydraulic fluid returning from the hydraulic load back to the reservoir and into the hydraulic pump. Each hydraulic pump may be mechanically coupled to an AC electric motors that are each electrically coupled to an electric AC inverter, each inverter receiving electrical power from the propulsion battery. Alternatively, any of the motors could be DC motors and receive power directly from the house battery or a DC-to-DC converter.

According to another embodiment, the auxiliary system 700 may include one or more electric motors. In particular, the auxiliary system 700 may incorporate one or more special purpose electric AC or DC motors. The electric motors can be mechanically coupled to mechanical actuators for the purposes to include but not limited to: moving cargo goods horizontally along the length and width of the trailer or vertically from the ground to any place on or above the trailer bed, e.g., a lift gate; operating actuators to position aerodynamic surfaces dynamically to optimize aerodynamic trailer drag for any specific speed or wind condition; push, pull, rotate, lift, or drop objects of some weight, positioning steering wheels added to the trailer, e.g., a trailer dolly; opening and closing doors and vents; operate ventilation fans or blowers; provide power to operate a trailer mounted refrigeration unit for “reefer” trailers. According to one embodiment, the propulsion battery may be electrically coupled to or otherwise configured to provide high voltage DC power to and receive high voltage DC power from a high voltage DC bus (the high voltage DC bus being electrically coupled to the charger/controller/inverter of the motor/generator). For example, AC motors may be electrically coupled to and receive power from AC inverters that are electrically coupled to the high voltage DC bus. Similarly, DC motors may be electrically coupled to and receive power from DC to DC converters that are electrically coupled to the high voltage DC bus or directly from the high voltage DC bus.

Alternatively, the electric motors can receive power from the low voltage DC bus that is electrically coupled to the low voltage house battery. The low voltage house battery can be at a nominal bus voltage at a value between 12 VDC and 50 VDC. AC motors can receive power from an AC inverter that is electrically coupled to the low voltage DC bus. DC motors can receive power from a DC to DC converter that is electrically coupled to the low voltage DC bus.

According to another embodiment, the auxiliary system 700 may include one or multiple unmanned drone docking ports. The unmanned drone docking port may include the electrical and mechanical connections to recharge the unmanned drone batteries from the high voltage buss and/or the low voltage house battery system. The unmanned drone docking port may also include a mechanical structure for supporting the unmanned drone during transport, launch, and recovery. The unmanned drone docking port may also include electrical and/or hydraulic systems as described above for moving the unmanned drone. The unmanned drone docking port may also include a wireless communication system for operation of the unmanned drone or multiple unmanned drones and status reporting to the trailer master control computer.

The trailer steering system 800 may include at least one means for steering the electric freight trailer 100. In particular, the trailer steering system 800 may include rear wheel steering or front wheel steering. With rear steering, the trailer steering system 800 may include two motors, one for each wheel on the drive axle, controlled separately for plus or minus wheel torque to apply a rotating torque for the trailer around the center of the drive axle. A single propulsion motor rotates a shaft going into the rear axle differential gear. Each wheel has a separately controlled brake which, together with the propulsion motor, can apply a differential retailer rotating torque around the center of the trailer drive axle. The motors may be the drive motor/generators or may be independent, dedicated steering motors.

With front steering, the trailer steering system 800 may be generally configured as one or two deployable shafts located at the front of the trailer in the area of the jack stands or kingpin. For example, the trailer steering system 800 may include a steering mechanism with one or more wheels at the bottom, a shaft being rotatable and connected to a gear that is connected to another rotatable gear on the end of an electric motor shaft. The electric motor can have its own wired or wireless remote control or be controlled by the master computer control unit. Other embodiments can be made by one skilled in the art.

According to one embodiment, the trailer steering system 800 may include steering shaft mechanically connected to a steering gear and electric motor controlled by the trailer computer to rotate the steering shaft and turn the trailer in either direction, left or right. At the bottom of the steering shaft it has one or more wheels to support the front trailer weight. The steering shaft may be mounted near the trailer kingpin to take advantage of the standard support structure for the kingpin. The shaft may or may not include a spring, hydraulic piston, or air piston for shock absorption. The shaft may include a mechanism to be stowed at the front of the trailer, and deploy the shaft when needed, similar to the nose wheel steering of an aircraft landing gear. The steering shaft may include a manual, electric or hydraulic jack to lift and lower the front of the trailer off and on the front trailer skids and/or the towing vehicle fifth wheel.

According to one embodiment, the trailer steering system 800 may be a retrofit to, or adaptation of standard trailer features. In particular, the trailer steering system 800 may include steerable wheels with a turning mechanism that receives power from the trailer are added to the standard trailer front skids. These wheels operate similar to the steering shaft described above and can be manually or automatically deployed.

According to one embodiment, the trailer steering system 800 may be configured for self-parking operations. In particular, one or more of the steering means/mechanisms of the electric freight trailer 100 may be operable by the controller 500 and/or the remote user interface 900 such that the electric freight trailer 100 may be decoupled from a prime mover and “parked” or otherwise maneuvered over a short distance and potentially in tight spaces or with additional complicating factors (e.g., inclement weather, reduced visibility, dangerous conditions, etc.). For example, the electric freight trailer 100 may be operable over-the-road with a driver operating the tractor unit 10 and/or autonomously with the autonomous tow vehicle 1000, but separated or otherwise decoupled from the prime mover upon arrival to delivery location. Then the electric freight trailer 100 may be maneuvered by a driver (via remote user interface 900) or autonomously, using one or more steering means of the trailer steering system 800. When “parking” autonomously, the electric freight trailer 100 may rely solely on the trailer steering system 800, a steering dolly (e.g., autonomous tow vehicle 1000), or any combination thereof to position, maneuver, and back itself. This feature may be highly beneficial to operators, as parking may be very challenging and not all drivers have equal skills in this area.

Together the electric freight trailer 100 and the autonomous tow vehicle 1000 may combine as an autonomous electric semi-trailer truck 2000. Alternately, the electric freight trailer 100 may be configured to couple with a tractor unit 10 (FIG. 8). Together the electric freight trailer 100 and the tractor unit 10 may combine similar to a conventional semi-trailer truck including a tractor and one or more semi-trailers.

The remote user interface 900 may be configured to operate, to augment, and/or to override one or more features of the electric freight trailer 100. According to one embodiment, the remote user interface 900 may be a dedicated, standalone device, such as a tethered controller. According to another embodiment, the remote user interface 900 may be embodied as software (e.g., an application) installed on another electronic device (e.g., smart phone, tablet computer, and the like).

The remote user interface 900 may be communicably coupled to the electric freight trailer 100 by at least one of a wired connection and a wireless communication link or wireless module. For example, the wireless communication link may be configured for the purposes of, but not be limited to, exchanging CAN bus information between the towing tractor and the towed trailer; provide trailer status information to the driver; accept trailer control inputs from the driver such as battery energy storage level, auxiliary lighting control, brake pedal, accelerator pedal, and steering inputs for trailer antiskid assist; trailer location and operation log history for maintenance predictions; performance analysis; fail safe control; and funding reimbursement.

Where the remote user interface 900 includes the wireless link/wireless module, it can include a transmitter and a receiver configured for at least half duplex communications. For example, the transmitter may be coupled to the standard truck tractor “glad hands” connection ports and configured to communicate with the receiver upon sensing the two line air pressures, or otherwise determines the glad hands are coupled. Further, the receiver may be mounted on the trailer and connected electrically to the trailer control computer (controller 500). Alternatively, the transmitter and the receiver can be two transceivers configured for a full duplex communications.

Aspects of the wireless module may be independently powered and/or operated. For example, the wireless link may have one of either a transmitter or transmitter/receiver connected to the standard truck tractor low voltage interface connector, and one of either a receiver or transmitter/receiver (transceiver) mounted on the trailer and connected electrically to the trailer control computer. According to one embodiment, the receiver or transceiver may be mounted on the trailer frame underneath the fifth wheel plate of the towing vehicle.

In operation, the wireless link (along with the controller 500) may be configured to provide remote on/off for trailer master control. The wireless link (along with the controller 500) may also be configured to provide remote control and monitoring of the refrigeration system on reefer trailers. The wireless link may be configured to provide a path for remote control of a steering dolly attached underneath the fifth wheel tow bar.

According to one embodiment, thrust sensors on the electric freight trailer 100 could be mounted underneath the kingpin plate at the thrust point of the kingpin for sensing the acceleration/deceleration and side forces (force vector) on the kingpin, these thrust sensors connected electrically or wirelessly to and communicating with the trailer control computer. According to one embodiment, a combination of the air pressure and low voltage connections with electrical connections to sensors may be replaced with the wireless link. In turn, the transmitter or transceiver for the wireless link may wirelessly communicate sensor data and other information to a receiver or transceiver mounted on the trailer and electrically communicating with the trailer control computer. Aspects of the wireless module may extend beyond direct command and operation of the electric freight trailer 100, and may include environmental sensing, navigation, and guidance systems, which may be beneficial when adapted as an autonomous ground vehicle (discussed below). In this configuration, the wireless module and or the controller 500 may integrate or otherwise include navigation radios and sensors such as GPS, LIDAR, RADAR, video, V2V, cell tower locators, imbedded ground magnets, and beacon/waypoint communications.

Preferably, the wireless communication link will include safeguards and redundancies. For example, the wireless link may incorporate frequency hopping and multipath radio transmission technology to prevent jamming and hacking. Further, the wireless link may be configured to provide a control path for fail safe operation where the motor/generator is disabled into a coast mode where the trailer operates as a standard trailer without any braking or acceleration assist.

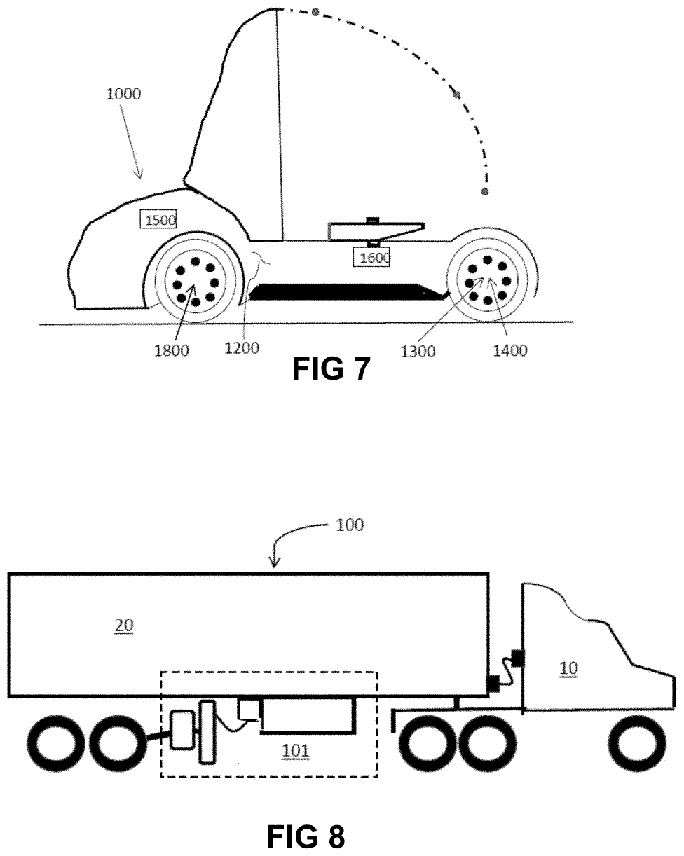

FIG. 7 schematically illustrates an autonomous dolly for an electric freight trailer, according to one embodiment of the disclosure. As above, the electric freight trailer 100 may be configured to couple with the autonomous tow vehicle 1000 or other steerable dolly. Together the electric freight trailer 100 and the autonomous tow vehicle 1000 may combine as an autonomous electric semi-trailer truck 2000 or an autonomous electric (full) trailer. As shown, the autonomous tow vehicle 1000 may include a tow chassis 1200, a tow steering system 1800, and a trailer interface 1900.

The tow chassis 1200 is broadly understood to be a mobile base adapted to support and maneuver the electric freight trailer 100. The tow chassis 1200 may be generally configured as a driverless four- or six-wheel ground vehicle and platform of a variety of the steerable dolly's systems. According to one embodiment, the tow chassis 1200 may include a deployable air fairing, which may be deployed prior to coupling with the electric freight trailer 100.

The tow steering system 1800 similarly is broadly understood and may include any of the steering means described above, as well as 4-wheel steering. Further, the steerable dolly may include a powered rotatable disk mounted around where the trailer kingpin locks onto the fifth wheel mount of the tow dolly. The rotatable disk may be rotated by gears and electric motor power and control from the trailer. As the disk rotates it turns the tow dolly and wheels to perform the steering function. In this way, the autonomous tow vehicle 1000 may have a higher degree of maneuverability than a traditional tractor.

The trailer interface 1900 may include one or more of a structural mount/physical couple to the electric freight trailer 100, a communication couple, and a power supply couple. For example, the physical couple may be embodied as a fifth wheel or kingpin couple (e.g., fifth wheel mounting plate configured to connect to the kingpin of the electric freight trailer 100). Also for example, the communication couple may include at least one of a wireless or wired connection to the trailer control computer (controller 500) and/or the remote user interface 900 of the electric freight trailer 100. Also for example, the power supply couple may include at least one of a wired (e.g., power cable) or wireless (e.g. inductive couple) connection configured to electrically couple with one or more power supplies of the electric freight trailer 100. According to one embodiment, the communication couple and the power supply couple may be combined. Additionally, the communication couple may be embodied as a communications link configured to communicably couple with at least one of the controller 500 of the electric freight trailer 100 and an independent dolly control interface, for example for controlling the steering wheels (trailer steering system 800)

The autonomous tow vehicle 1000 may further include an onboard power supply 1600. The onboard power supply 1600 may be embodied as an independent power supply or incorporate the power supply couple and provide remote power onboard. As an independent power supply, the onboard power supply 1600 may be embodied as at least one of a low voltage battery (e.g. for house loads or steering) or a high voltage energy storage (e.g., for steering, traction, braking). Alternately, the onboard power supply 1600 may incorporate both local energy storage and remote energy storage.

The autonomous tow vehicle 1000 may further include at least one of a tow drive system 1300 and a tow braking system 1400, both of which being adapted for movement and maneuvering of the electric freight trailer 100, for example, as a tug vehicle or a tow dolly. Preferably, the tow drive system 1300 will be powered electrically, similarly to the electric freight trailer 100. Likewise, the tow braking system 1400 will preferably incorporate regenerative braking and/or friction braking. Both the tow drive system 1300 and the tow braking system 1400 may electrically couple with and communicate power with the onboard power supply 1600.

According to one embodiment, the autonomous tow vehicle 1000 may be configured for drone/autonomous operation in coordination with the electric freight trailer 100. In particular, the autonomous tow vehicle 1000 may include the independent power supply, configured to move and steer the autonomous tow vehicle 1000 prior to coupling with the electric freight trailer 100, upon which the electric freight trailer 100 provides traction via the motors/generators, and the steerable dolly merely provides steering. This may be especially significant for applications at warehouses and distribution centers for more efficient, cost savings, and fuel saving operation.

According to one embodiment, the steerable dolly (autonomous tow vehicle 1000) may further include a navigation and control system 1500. Similar to above, the navigation and control system 1500 of the autonomous tow vehicle 1000 may integrate or otherwise include navigation radios and sensors such as GPS, LIDAR, RADAR, video, V2V, cell tower locators, embedded ground magnets, and beacon/waypoint communications. The navigation and control system 1500 may further integrate or otherwise utilize environmental sensing, navigation, and guidance systems of the electric freight trailer 100, for example via communication couple of the trailer interface 1900 to the wireless module and/or the controller 500 of the electric freight trailer 100.

FIG. 8 schematically illustrates a freight trailer retrofitted as an electric freight trailer, according to another embodiment of the disclosure. In particular, one or more aspects of the electric freight trailer 100 described above may be retrofitted or otherwise added on to a conventional semi-trailer. For example, the chassis 200 described above may generally be embodied as any conventional semi-trailer (e.g., a flat bed, tank, refrigeration box/reefer, dry goods box, multimodal removable container, or any other custom trailer), which is augmented to include suitable mountings, power, and communications to support the additional features of the electric freight trailer 100 described above. Accordingly, one or more aspects of the electric freight trailer 100 described above may be retrofitted or otherwise added as part of an electric freight trailer retrofit 101. One particular benefit to retrofitting a conventional semi-trailer as an electric freight trailer 100 (or otherwise replacing it with the same), is that the electric and air pressure “glad hands” connections links between the tractor and the trailer may be removed. This is because the semi-trailer has its own air compressor supplying the air brakes, and house battery for electric power. Moreover, the trailer can operate completely independent of the towing tractor by only sensing the pull during acceleration and the push during braking deceleration. Sensing the deceleration push from the trailer controls the brake lights on the rear of the trailer. The trailer can also sense the light level of the environment to automatically turn on and off the running lights. Other benefits will be readily apparent to persons of ordinary skill in the art as well as operators of semi-trailers.

The disclosure has been sufficiently described so that a person of ordinary skill in the art can reproduce and obtain the results mentioned in the present disclosure. However, any skilled person in the field of the art of the present disclosure may be able to make modifications not described in the present application. Notwithstanding, if these modifications require a structure or manufacturing process not described in the present disclosure, the modifications should be understood to be within the scope of the claimed descriptions in the present disclosure.

1. A system for a freight trailer, the freight trailer having a chassis, at least one drive wheel, and an air-powered braking system, the system comprising:
an onboard drive system affixable to the freight trailer, said onboard drive system including an energy storage and a motor/generator electrically coupled to the energy storage, the motor/generator configured to apply torque to the at least one drive wheel, the energy storage configured to power the motor/generator and be charged by the motor/generator;
an onboard air system affixable to the freight trailer, said onboard air system including an air compressor, an air pressure tank, and a supply-air line, said supply-air line pneumatically coupleable to the air-powered braking system of the freight trailer, the air compressor configured to fill the air pressure tank, the air pressure tank pneumatically coupled to the supply-air line and configured to provide supply air to the air-powered braking system of the freight trailer;
a power distribution system electrically coupled to the energy storage of the onboard drive system, the power distribution system configured to electrically power the air compressor of the onboard air system; and
a controller affixable to the freight trailer, said controller configured to operate the onboard drive system and the onboard air system in both propulsion and braking.

2. The system of claim 1, wherein the onboard air system further includes a brake controller and a service-air line, the brake controller configured to communicate brake commands from a trailer operator to the onboard air system, the service-air line pneumatically coupleable to the air-powered braking system of the freight trailer, the air pressure tank further pneumatically coupled to the service-air line, the onboard air system further configured to provide service air to the air-powered braking system of the freight trailer responsive to the brake commands of the trailer operator communicated to the onboard air system via the brake controller.

3. The system of claim 2, wherein the brake controller includes a tractor braking control interface affixable to a tractor, said tractor braking control interface configured to signal an application of a tractor air-powered braking system by the trailer operator; and
wherein the onboard air system further configured to provide supply air and service air to the air-powered braking system of the freight trailer responsive to the brake commands of the trailer operator communicated to the onboard air system via the tractor braking control interface of brake controller.

4. The system of claim 3, wherein the tractor braking control interface includes a pressure transducer pneumatically coupled to a tractor service-air line, said pressure transducer configured to signal the application of the tractor air-powered braking system by the trailer operator in response to sensed pressured in the tractor service-air line; and
wherein the tractor braking control interface is further configured to signal the application of the tractor air-powered braking system by the trailer operator via a wireless communication link.

5. The system of claim 4, further comprising a means for steering the electric freight trailer; and
wherein the power distribution system is further configured to electrically power the means for steering the electric freight trailer.

6. The system of claim 5, further comprising a remote user interface, said remote user interface configured to operate the controller and the means for steering the electric freight trailer such that the electric freight trailer may be maneuvered under its own propulsion and braking when decoupled from a prime mover.

7. The system of claim 6, wherein the onboard drive system, the onboard air system, the power distribution system, the controller, the means for steering the electric freight trailer, and the remote user interface are arranged as a retrofit kit configure to convert a conventional freight trailer into an electrified freight trailer.

8. The system of claim 1, wherein the onboard drive system is configured to operate at a first voltage;
wherein the onboard air system is configured to operate at a second voltage, said second voltage being no more than half the first voltage; and
wherein the power distribution system is configured convert power from the first voltage to the second voltage.

9. The system of claim 8, further comprising:
an auxiliary system powered by the power distribution system, said auxiliary system including at least one of a hydraulic pump, an electric actuator, and a refrigerant compressor; and
a household power system powered by the power distribution system, said household power system including a house battery, the household power system configured to provide at least one of 110/220 VAC and 12 VDC to 48 VDC that is usable onboard the freight trailer.

10. The system of claim 9, wherein the controller is configured to operate the onboard drive system to coordinate propulsion of the freight trailer with a prime mover tractor, and to coordinate braking of the freight trailer with air-powered braking system of the freight trailer; and
wherein the controller is further configured to operate the auxiliary system powered and the household power system.

11. An electrified trailer comprising:
a freight trailer having a chassis, at least one drive wheel, and an air-powered braking system;
an onboard drive system fixed to the freight trailer, said onboard drive system including an energy storage and a motor/generator electrically coupled to the energy storage, the motor/generator configured to apply torque to the at least one drive wheel, the energy storage configured to power the motor/generator and be charged by the motor/generator;
an onboard air system fixed to the freight trailer, said onboard air system including an air compressor, an air pressure tank, and a supply-air line, said supply-air line pneumatically coupled to the air-powered braking system of the freight trailer, the air compressor configured to fill the air pressure tank, the air pressure tank pneumatically coupled to the supply-air line and configured to provide supply air to the air-powered braking system of the freight trailer;
a power distribution system electrically coupled to the energy storage of the onboard drive system, the power distribution system configured to electrically power the air compressor of the onboard air system; and
a controller fixed to the freight trailer, said controller configured to operate the onboard drive system and the onboard air system in both propulsion and braking.

12. The system of claim 11, wherein the onboard air system further includes a brake controller and a service-air line, the brake controller configured to communicate brake commands from a trailer operator to the onboard air system, the service-air line pneumatically coupleable to the air-powered braking system of the freight trailer, the air pressure tank further pneumatically coupled to the service-air line, the onboard air system further configured to provide service air to the air-powered braking system of the freight trailer responsive to the brake commands of the trailer operator communicated to the onboard air system via the brake controller.

13. The system of claim 12, wherein the brake controller includes a tractor braking control interface affixable to a tractor, said tractor braking control interface configured to signal an application of a tractor air-powered braking system by the trailer operator; and
wherein the onboard air system further configured to provide supply air and service air to the air-powered braking system of the freight trailer responsive to the brake commands of the trailer operator communicated to the onboard air system via the tractor braking control interface of brake controller.

14. The system of claim 13, wherein the tractor braking control interface includes a pressure transducer pneumatically coupled to a tractor service-air line, said pressure transducer configured to signal the application of the tractor air-powered braking system by the trailer operator in response to sensed pressured in the tractor service-air line; and
wherein the tractor braking control interface is further configured to signal the application of the tractor air-powered braking system by the trailer operator via a wireless communication link.

15. The system of claim 14, further comprising a means for steering the electric freight trailer; and
wherein the power distribution system is further configured to electrically power the means for steering the electric freight trailer.

16. The system of claim 15, further comprising a remote user interface, said remote user interface configured to operate the controller and the means for steering the electric freight trailer such that the electric freight trailer may be maneuvered under its own propulsion and braking when decoupled from a prime mover.

17. The system of claim 16, further comprising:
an auxiliary system powered by the power distribution system, said auxiliary system including at least one of a hydraulic pump, an electric actuator, and a refrigerant compressor; and
a household power system powered by the power distribution system, said household power system including a house battery, the household power system configured to provide at least one of 110/220 VAC and 12 VDC to 48 VDC that is usable onboard the freight trailer; and
wherein the onboard drive system is configured to operate at a first voltage;
wherein the onboard air system is configured to operate at a second voltage, said second voltage being no more than half the first voltage;
wherein the power distribution system is configured convert power from the first voltage to the second voltage;
wherein the controller is configured to operate the onboard drive system to coordinate propulsion of the freight trailer with a prime mover tractor, and to coordinate braking of the freight trailer with air-powered braking system of the freight trailer; and
wherein the controller is further configured to operate the auxiliary system powered and the household power system.

18. The system of claim 17, wherein the household power system is further configured to provide at least one of 110/220 VAC and 12 VDC to 48 VDC that is usable offboard the freight trailer.

19. A method for moving a freight trailer, the method comprising:
providing an electrified trailer, said electrified trailer including
a freight trailer having a chassis, at least one drive wheel, and an air-powered braking system,
an onboard drive system fixed to the freight trailer, said onboard drive system including an energy storage and a motor/generator electrically coupled to the energy storage, the motor/generator configured to apply torque to the at least one drive wheel, the energy storage configured to power the motor/generator and be charged by the motor/generator,
an onboard air system fixed to the freight trailer, said onboard air system including an air compressor, an air pressure tank, and a supply-air line, said supply-air line pneumatically coupled to the air-powered braking system of the freight trailer, the air compressor configured to fill the air pressure tank, the air pressure tank pneumatically coupled to the supply-air line and configured to provide supply air to the air-powered braking system of the freight trailer,
a means for steering the electric freight trailer,
a power distribution system electrically coupled to the energy storage of the onboard drive system, the power distribution system configured to electrically power the air compressor of the onboard air system and to electrically power the means for steering the electric freight trailer, and
a controller fixed to the freight trailer, said controller configured to operate the onboard drive system and the onboard air system in both propulsion and braking;
propelling the electrified trailer via the onboard drive system;
braking the electrified trailer via the onboard air system, and
steering the electrified trailer via the means for steering the electric freight trailer.

20. The method of claim 19 wherein the electrified trailer further includes
an auxiliary system powered by the power distribution system, said auxiliary system including at least one of a hydraulic pump, an electric actuator, and a refrigerant compressor, and
a household power system powered by the power distribution system, said household power system including a house battery, the household power system configured to provide at least one of 110/220 VAC and 12 VDC to 48 VDC that is usable onboard the freight trailer; and
wherein the onboard drive system is configured to operate at a first voltage;
wherein the onboard air system is configured to operate at a second voltage, said second voltage being no more than half the first voltage;
wherein the power distribution system is configured convert power from the first voltage to the second voltage;
wherein the controller is configured to operate the onboard drive system to coordinate propulsion of the freight trailer with a prime mover tractor, and to coordinate braking of the freight trailer with air-powered braking system of the freight trailer; and
wherein the controller is further configured to operate the auxiliary system by the power distribution system and the household power system; and
the method further comprises:
operating at least one of the hydraulic pump, the electric actuator, and the refrigerant compressor via the auxiliary system; and
providing at least one of 110/220 VAC and 12 VDC to 48 VDC that is usable onboard the freight trailer via the household power system.
